(19) United States
(12) Patent Application Publication
(10) Pub. No.: US 2002/0111064 A1
(43) Pub. Date: Aug. 15, 2002

(54) Bottom entry connector

(76) Inventor: Toshiaki Kohno, Tokyo (JP)

Correspondence Address: Bruce J. Wolstoncroft, Barley, Snyder, Senft & Cohen, LLC, 126 East King Street, Lancaster, PA, 17602-2893, US

(21) Appl. No.: 10/054,622

(22) Filed: Jan. 22, 2002

(30) Foreign Application Priority Data
Feb. 15, 2001 (JP) 2001-38926

(51) Int. Cl. H02B 1/01

(52) U.S. Cl. 439/547

(57) ABSTRACT

A connector (100) for mounting through an opening (30c) of a substrate (30) has a housing (20) with contacts (10) provided therein, the contacts (10) have substrate connecting portions (10a) which are configured to make electrical connection with contact pads provided on a first surface (30a) of the substrate (30). At least one reinforcing member (40) is mounted to the housing (20), the at least one reinforcing member (40) has a substrate fixing portion (42) and a resilient arm (43), the resilient arm (43) cooperates with edges of the opening (30c) to prevent movement of the connector (100) relative to the opening (30c) until the substrate fixing portion (42) and the substrate contacting portions (10a) are soldered to the substrate (30).

### FIELD OF THE INVENTION

The present invention relates to a bottom entry connector having a mating portion mating with a complementary connector on a surface on an opposite side of a mounting surface of a substrate. More particularly, it relates to a technology effective in mounting the bottom entry connector to the substrate easily and surely.

### DESCRIPTION OF THE PRIOR ART

A conventional bottom entry connector 110, as shown in FIGS. 7(A) and 7(B), includes a plurality of socket contacts 11 and a housing 12 for accommodating the socket contacts 11 (see Japanese Utility Model Laid-Open No. 3-79170).

The socket contacts 11 are arranged in two rows between a plurality of holding portions 12e formed in the lengthwise direction (right-and-left direction in FIG. 7A) so as to project from a top face of the housing 12. Each of the socket contacts 11 comprises a press-fit portion 11b which is pressed and secured in the housing 12, a substrate connecting portion 11a which is connected to a substrate 13, and a contact portion 11c which makes contact with a contact on the mating side. The contact portion 11c extends downward from the press-fit portion 11b in FIG. 7B, and has a U-like shape for holding the mating contact. Also, the substrate connecting portion 11a is formed by being extended upward from the contact portion 11c and by being bent almost perpendicularly along a top surface 13a of the substrate 13 so as to project from a side wall in the width direction (right-and-left direction in FIG. 7B) of the housing 12.

The housing 12 has a substantially rectangular shape extending in the lengthwise direction. The housing has a mating portion 12a for mating with a complementary connector. The mating portion is formed on a lower side (lower side in FIG. 7A) of the housing 12. A pair of gripping portions 12d are integrally formed so as to project upward from both side walls in the lengthwise direction (right-and-left direction in FIG. 7A) of the mating portion 12a. In the mating portion 12a, a plurality of accommodating holes 12b for accommodating and holding the contact portion 11c of the socket contact 11 are arranged in two rows in the lengthwise direction. In the bottom surface of the mating portion 12a, insertion holes 12c, into which the mating contacts are inserted, are opened. The insertion holes 12c extend from the bottom surface to the accommodating holes 12b. Also, on both the side walls of the gripping portions 12d, a flat plate shaped reinforcing metal member 14 is mounted in a position having a height approximately equal to that of the substrate connecting portion 11a of the socket contact 11 so as to project horizontally from the side wall in the lengthwise direction (right-and-left direction in FIG. 7A) of the mating portion 12a.

The substrate 13 is formed with a rectangular opening 13c having a size approximately equal to that of the mating portion 12a so that the mating portion 12a of the bottom entry connector 110 can be inserted therein. Also, at the peripheral edges in the lengthwise direction on the side of the top surface 13a of the opening 13c, a plurality of connection pads 15a are arranged so as to correspond to the socket contacts 11. Similarly, at the peripheral edges in the width direction, a mounting pad (not shown) is arranged so as to correspond to the reinforcing metal member 14.

In order to mount the bottom entry connector 110 constructed as described above to the substrate 13, the gripping portions 12d are first gripped by fingers etc. to insert the mating portion 12a into the opening 13c formed in the substrate 13 from the side of the top surface 13a, that is, one surface side. Then, a positioning process is performed in which the substrate connecting portions 11a of the socket contacts 11 are mounted on the connection pads 15a, and the reinforcing metal members 14 are mounted on the mounting pads. Since the opening 13c formed in the substrate 13 has a size approximately equal to that of the mating portion 12a, the mating portion 12a is inserted therein and projects to the side of a bottom surface 13b, that is, the other surface side. The reinforcing metal members 14 projecting horizontally from the mating portion 12a are mounted on the side of the top surface 13a, that is, one surface side of the substrate 13.

Next, the bottom entry connector 110 is moved to a soldering process in the state in which the substrate connecting portions 11a of the socket contacts 11 and the reinforcing metal members 14 are mounted on the side of the top surface 13a of the substrate 13. In this process, soldering is performed by reflow treatment in which the connection pads 15a and the mounting pads to which solder paste is applied are heated collectively, by which the mounting of the bottom entry connector 110 to the substrate 13 is completed. Since the reinforcing metal members 14 and the substrate connecting portions 11a of the socket contacts 11 are soldered to the substrate 13, a stress applied to the soldered portion of the socket contact 11 will be distributed, so that the bottom entry connector 110 can be fixed firmly to the substrate 13.

By inserting the mating portion of the complementary connector from the side of the bottom surface 13b, that is, the other surface side of the substrate 13, the contact portions 11c of the socket contacts 11 are electrically connected to pin contacts on the mating side.

However, in the above-described mounting process, as positioning of the connector 110 is performed by mounting the substrate connecting portions 11a of the socket contacts 11 and the reinforcing metal members 14 at the peripheral edges of the opening 13c on the side of the top surface 13a of the substrate 13, there is a possibility that the connector 110 shifts before soldering occurs. For this reason, when soldering occurs, the positioning of the connector 110 must be controlled to insure that the connector 110 is properly positioned. This increases the costs and requires additional time. Consequently, the efficiency of manufacture is reduced. In some instances, the connectors 110 are not properly positioned, causing the electrical continuity between the substrate 13 and the bottom entry connector 110 to become intermittent and/or ineffective.

As the positioning of the connector 110 is performed by mounting the substrate connecting portions 11a of the socket contacts 11 and the reinforcing metal members 14 at the peripheral edges of the opening 13c on the side of the top surface 13a of the substrate 13, it is difficult for an installer or worker to confirm whether or not the connector is properly mounted.

The reinforcing metal members 14 are formed so as to project horizontally from the opening 13c formed in the substrate 13 so that, if the bottom entry connector 110 is inserted from the side of the top surface 13a of the substrate 13, the reinforcing metal members 14 are mounted at the peripheral edges of the opening 13c on the side of the top surface 13a of the substrate 13. However, if the connector is inserted from the side of the bottom surface 13b of the substrate 13, the reinforcing metal members are ineffective and thus the mounting is difficult to perform. Therefore, the conventional bottom entry connector 110 is often mounted from the side of the top surface 13a of the substrate 13, which places a restriction on the application of the bottom entry connector 110.

### SUMMARY OF THE INVENTION

The present invention has been achieved in view of the above situation, and accordingly an object thereof is to provide a bottom entry connector in which the bottom entry connector can be securely and easily fixed to a substrate, the installer can confirm the completion of mounting, and the application of the bottom entry connector can be broadened.

A bottom entry connector has a contact, a housing for accommodating the contact, and a reinforcing metal member. The connector is mounted to a substrate by inserting a mating portion formed on the housing, from one surface side of an opening formed in the substrate to project the mating portion to the other surface side of the substrate. A substrate connecting portion of the contact and a substrate fixing portion of the reinforcing metal member are soldered to the one surface side of the substrate. The reinforcing metal member is provided with a resilient arm which engages with a peripheral edge of the opening on the other surface side of the substrate.

The resilient arm, which engages with the peripheral edge of the opening on the side opposite to the mounting surface side (one surface side), that is, the bottom surface side (the other surface side) of the substrate, insures that the bottom entry connector can be fixed to the substrate. Therefore, once the connector is positioned in the opening and moved to a soldering station or the like, the resilient arms will prevent relative movement of the connector with respect to the substrate, thereby insuring that the connector will be properly positioned during soldering.

Also, due to the resilient force of the resilient arm, an audible click will occur as the connector is properly mated with the substrate, thereby allowing the installer or worker to know when the connector and substrate are properly mated. The worker can therefore easily and reliably confirm the completion of mounting.

By fixing the bottom entry connector to the substrate by using the resilient arm, the bottom entry connector can be fixed even if it is inserted from the bottom surface side of the substrate, that is, the downside of the substrate, and thus the bottom entry connector can be mounted from the bottom surface side of the substrate. Therefore, the usefulness of the bottom entry connector can be expanded to more applications. In order to accommodate the insertion of the connector, a tip end portion of the resilient arm is curved so as to engage with the peripheral edge of the opening in the substrate.

The resilient arm may be formed, by being bent in the vertical direction, between the paired substrate fixing portions formed in the horizontal direction into a flat plate shape. By forming the resilient arm between the paired substrate fixing portions, the resilient arm is protected by the paired substrate fixing portions. Therefore, a failure such as a bent resilient arm caused by an external force applied when the bottom entry connector is mounted to the substrate or an entangled electric wire can be effectively prevented.

A base portion of the reinforcing metal member is inserted and secured in the housing in the direction perpendicular to the mating direction of the complementary connector. By inserting and securing the base portion of the reinforcing metal member in the housing in the direction perpendicular to the mating direction of the complementary connector, the reinforcing metal member is prevented from coming off the housing against a force acting when the complementary connector is inserted or removed.

### BRIEF DESCRIPTION OF THE DRAWINGS

FIG. 1 is a perspective view of a bottom entry connector in accordance with the present invention.

FIG. 2 is a plan view showing a part of a substrate to which the bottom entry connector in accordance with the present invention is mounted.

FIGS. 3A and 3B are a plan view and a bottom view, respectively, showing the bottom entry connector in accordance with the present invention.

FIG. 4 is a front view including a sectional view taken along a line 4-4 of FIG. 3B, showing a state in which the bottom entry connector in accordance with the present invention is mounted to the substrate.

FIG. 5 is a sectional view taken along a line 5-5 of FIG. 3B, showing contacts provided in the bottom entry connector in accordance with the present invention.

FIG. 6A is a perspective view,

FIG. 6B is a plan view, and

FIG. 6C is a sectional view taken along the line 6C-6C of FIG. 6B, showing a reinforcing metal member of the bottom entry connector in accordance with the present invention.

FIGS. 7A and 7B are a perspective view and a sectional view, respectively, showing a bottom entry connector according to the prior art.

### DETAILED DESCRIPTION OF THE PREFERRED EMBODIMENTS

An embodiment of the present invention will now be described with reference to the accompanying drawings.

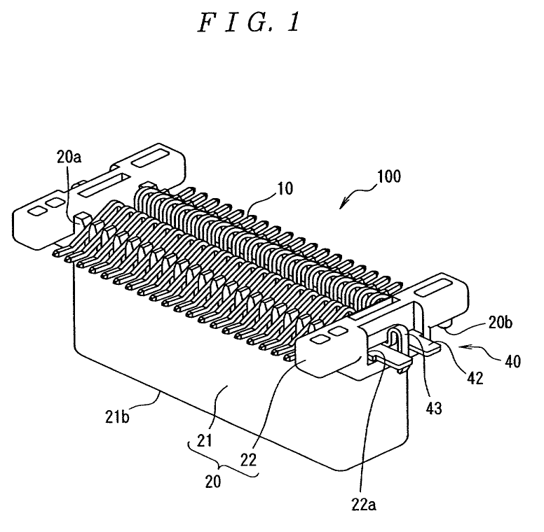

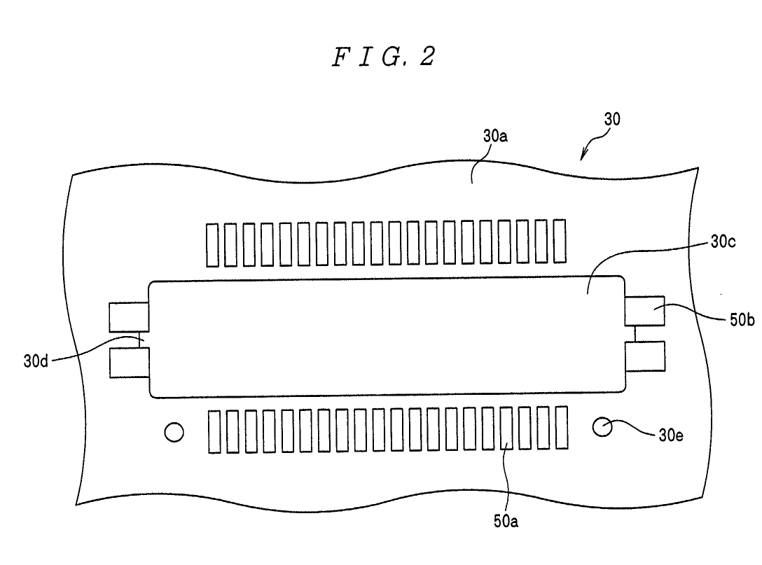

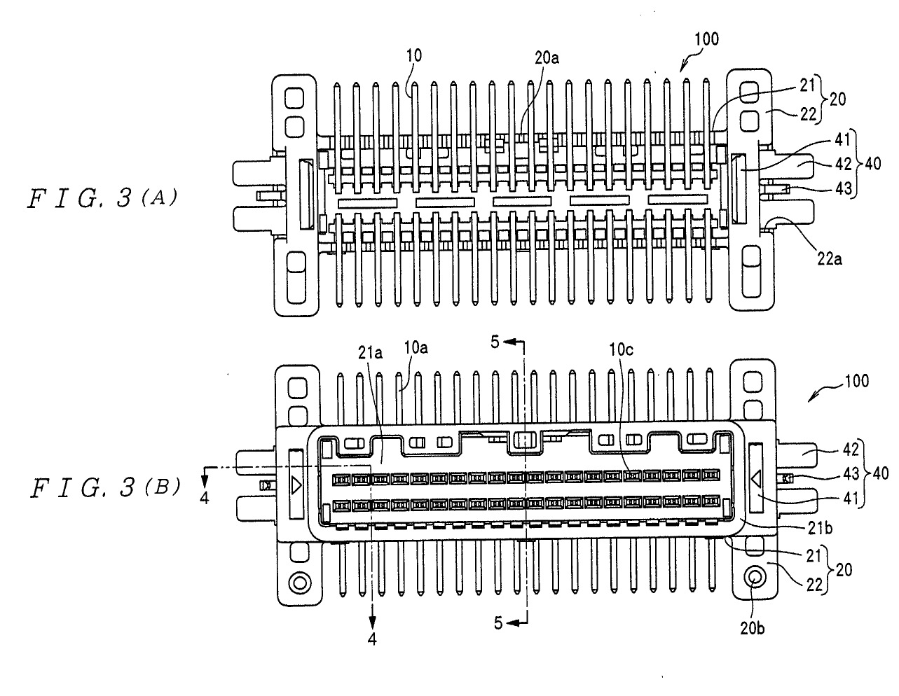

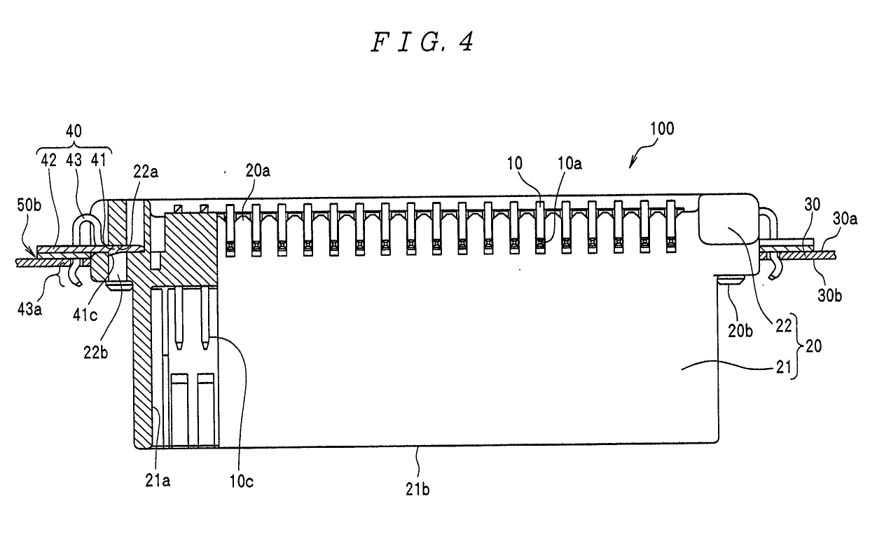

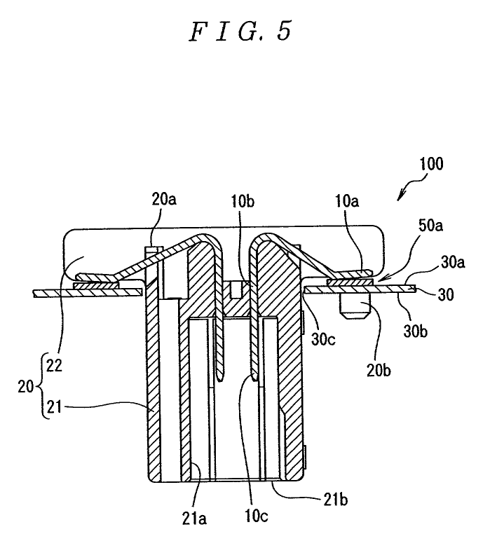

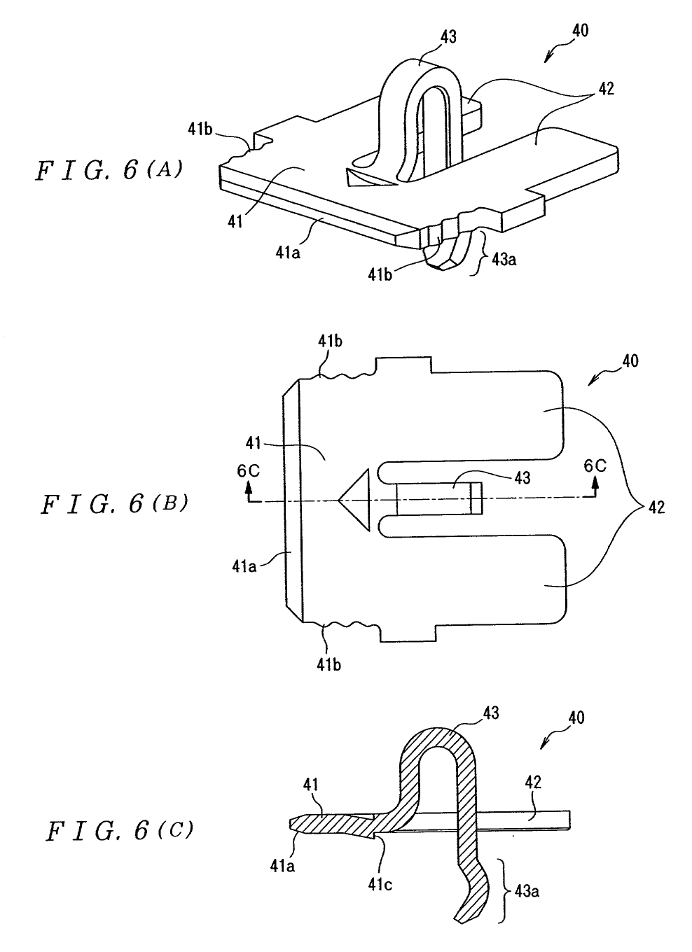

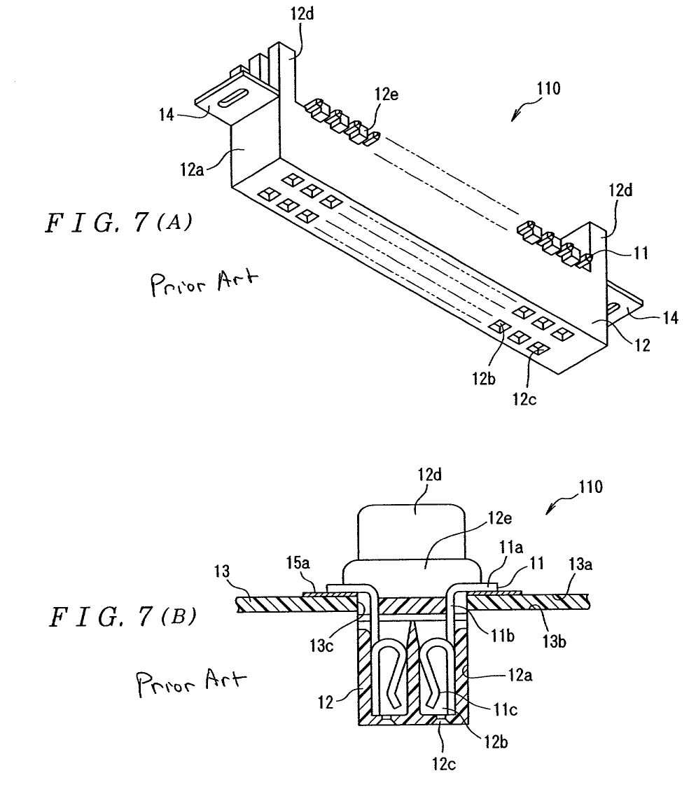

FIG. 1 is a perspective view of a bottom entry connector in accordance with the present invention. FIG. 2 is a plan view showing a part of a substrate to which the bottom entry connector in accordance with the present invention is mounted. FIGS. 3A and 3B are a plan view and a bottom view, respectively, showing the bottom entry connector in accordance with the present invention. FIG. 4 is a front view including a sectional view taken along a line 4-4 of FIG. 3B, showing a state in which the bottom entry connector in accordance with the present invention is mounted to the substrate. FIG. 5 is a sectional view taken along a line 5-5 of FIG. 3B, showing a state in which the bottom entry connector in accordance with the present invention is mounted to the substrate. FIG. 6A is a perspective view, FIG. 6B is a plan view, and FIG. 6C is a sectional view taken along the line 6C-6C of FIG. 6B, showing a reinforcing member of the bottom entry connector in accordance with the present invention.

As shown in FIG. 1, a bottom entry connector 100 in accordance with the present invention comprises a plurality of pin contacts 10, a housing 20 for accommodating and holding these pin contacts 10, and reinforcing metal members 40 which are soldered to a substrate 30 when the bottom entry connector 100 is mounted to the substrate 30.

As best shown in FIG. 5, the pin contact 10, which is formed of a conductive metallic material, has a substrate connecting portion 10a which engages a top surface 30a of the substrate 30 when the connector 100 is properly mounted on the substrate 30, a press-fit portion 10b press-fitted into the housing 20, and a contact portion 10c making contact with a socket contact (not shown) on the mating side. The substrate connecting portion 10a initially extends upward continuously from the press-fit portion 10b to above the top surface 30a of the substrate 30. The connecting portion 10a is bent back toward the top surface 30a to form a portion which extends diagonally with respect to the press-fit portion. The connecting portion 10a projects from the diagonal portion horizontally from a side wall in the width direction (right-and-left direction in FIG. 5) of a mating portion 21 of the housing 20. The connecting portion 10a is fixed by soldering to a connection pad 50a formed on the top surface 30a of the substrate 30. The contact portion 10c extends downward vertically so as to be continuous with the press-fit portion 10b.

The housing 20, which is formed of an insulating material, has a substantially rectangular shape extending in the lengthwise direction. The housing 20 has a mating portion 21 which houses the mating socket contact and gripping portions 22 formed integrally with the mating portion. The gripping portions project upward and horizontally from side walls in the lengthwise direction (right-and-left direction in FIG. 4) of the mating portion 21, as shown in FIG. 4.

The mating portion 21 includes a mating recess 21a that is open to the bottom surface to mate with the complementary connector. As shown in FIG. 4, in the mating recess 21a, a plurality of pin contacts 10 for making contact with the mating contact are accommodated and held so as to be arranged in the lengthwise direction in such a manner that the contact portion 10c is directed downward. The substrate connecting portion 10a of the pin contact 10 projects from the top face of the housing 20 as shown in FIG. 3A, and a plurality of holding portions 20a, which are formed so as to project from the top face of the housing 20, are arranged between the arranged pin contacts 10.

The gripping portion 22 is provided with a mounting opening 22a for mounting a reinforcing metal member 40 in the side wall in the lengthwise direction of the gripping portion 22. The mounting opening 22a is provided at a height which is approximately equal to the height of the horizontal portion of the substrate connecting portion 10a of the pin contact 10. The opening 22a extends in the plane of the connecting portions 10a. On the lower face of the gripping portion 22, a positioning protrusion 20b for positioning the bottom entry connector 100 to the substrate 30 is formed.

As shown in FIG. 6, the reinforcing metal member 40 has a substantially flat plate shape formed by stamping and forming sheet metal. The reinforcing member 40 includes a base portion 41, a pair of substrate fixing portions 42 projecting horizontally from the base portion 41, and a resilient arm 43 formed between the paired substrate fixing portions 42 by being bent from the base portion 41.

The base portion 41 is inserted horizontally in the mounting opening 22a provided in the side wall of the gripping portion 22 of the housing 20, and is press-fitted and secured therein. The press-fit end portion (left-hand side in FIG. 6B) of the base portion 41 is formed with a taper 41a for ease of press-fitting operation. The side walls (upper and lower portions on the left-hand side in FIG. 6B) of the base portion 41 are formed with a plurality of barbs 41b. In a central portion on the lower face side of the base portion 41, a protrusion 41c is provided for preventing the removal of the reinforcing metal member 40 from the mounting opening 22a. The barb 41b bites into the side wall of the mounting opening 22a when the base portion 41 is press-fitted into the mounting hole 22a. As shown in FIG. 4, when the base portion 41 is press-fitted into the mounting opening 22a, the protrusion 41c is located at an opening 22b extending downward from the mounting hole 22a to function as a locking element for preventing the reinforcing metal member 40 from being moved to the outside in the lengthwise direction (right-and-left direction in FIG. 4). Since the base portion 41 is press-fitted into the mounting hole 22a in the direction perpendicular to the mating direction (up-and-down direction in FIG. 4) of the bottom entry connector 100, the reinforcing metal member 40 is prevented from being removed from the housing 20 against a force acting when the complementary connector is inserted or removed.

When the bottom entry connector 100 is mounted on the substrate 30, the substrate fixing portion 42 are soldered to a mounting pad 50b formed on the top surface 30a of the substrate 30.

The resilient arm 43, having resiliency, is formed by being raised upward almost vertically from the base portion 41 and by being bent into a U-like shape. A tip end portion 43a of one leg of the U-shape has such a curved configuration. The curved face of the tip end portion 43a engages with the peripheral edge of an opening 30c in the substrate 30, by which the bottom entry connector 100 is securely held on the substrate 30.

The reinforcing metal member 40 may be integrally molded with the housing 20. However, this type of molding requires an intricate and relatively expensive mold. Therefore, in the embodiment shown, after the housing 20 is formed separately by using a simple mold, and the reinforcing metal member 40 is press-fitted into the housing 20.

Referring to FIG. 2, the substrate 30 is formed with the rectangular opening 30c having a size approximately equal to that of a mating face 21b so that the mating portion 21 of the housing 20 can be inserted therein. In a central portion on the short side (side extending in the upand-down direction in FIG. 2) of the opening 30c, a resilient arm engagement recess 30d extends away from the opening 30c. On the top surface 30a of the substrate 30, the connection pads 50a corresponding to the substrate connecting portions 10a of the pin contacts 10 are arranged along the lengthwise direction (right-and-left direction in FIG. 2) at the peripheral edges of the opening 30c. Similarly, the mounting pads 50b corresponding to the substrate fixing portions 42 of the reinforcing metal members 40 are arranged along the width direction (up-and-down direction in FIG. 2) at the peripheral edges of the opening 30c. In order to position the bottom entry connector 100 to the substrate 30, a positioning hole 30e for receiving the positioning protrusion 20b of the housing is provided at two places near the ends of the long side (side extending in the right-and-left direction in FIG. 2) of the opening 30c.

In order to mount the bottom entry connector 100 constructed as described above on the substrate 30, the gripping portions 22 formed in the housing 20 are first gripped by fingers etc. to insert the mating portion 21 into the opening 30c formed in the substrate 30 from the side of the top surface 30a, that is, one surface side. The positioning protrusions 20b of the bottom entry connector 100 must be positioned in alignment with the positioning holes 30e in order to allow the substrate 30 and the connector 100 to be mated together. When the bottom entry connector 100 is inserted from the side of the top surface 30a of the substrate 30, the mating portion 21 projects to the side of a bottom surface 30b, that is, the other surface side of the substrate 30. Subsequently, the curved face in the tip end portion 43a of the resilient arm 43 provided on the reinforcing metal member 40 is inserted along the peripheral wall of the opening 30c in the substrate 30. At this time, the tip end portion 43a of the resilient arm 43 is subjected to an inwardly urging force due to the engagement with the peripheral wall of the opening 30c. When the tip end portion 43a of the resilient arm 43 is inserted through the substrate 30, the aforementioned force is removed or significantly reduced, and thus the tip end portion 43a is returned to the outside by the resiliency of the resilient arm 43. The resilient arm 43 still exerts a minimal force on the peripheral wall of the opening, thereby insuring that the connector 100 remains properly positioned in the opening 30c. At this time, the tip end portion 43a of the resilient arm 43 is engaged with the side of the bottom surface 30b, that is, the other surface side of the substrate 30 while a click of engagement sound is given out. Since the reinforcing metal member 40 is provided so as to have a height equal to that of the substrate connecting portion 10a of the pin connector 10, the substrate connecting portion 10a of the pin contact 10 in the bottom entry connector 100 and the connection pad 50a make contact with each other, and also the substrate fixing portion 42 of the reinforcing metal member 40 and the mounting pad 50b make contact with each other. It is worth noting that the curved surface cooperates with the bottom surface 30b to insure that the connector is properly seated. As the resilient arms 43 are slightly biased against the peripheral wall, the shape of the tip end portion 43a will cause the connector 100 to be moved into proper engagement with the substrate 30.

With the connector properly positioned in the opening of the substrate, the bottom entry connector 100 and substrate 30 are moved to a soldering process. Due to the configuration of the resilient arms, the connector 100 is secured to the substrate 30 such that the positioning of the connector in the opening is controlled. During the soldering process, the pin contacts 10 and the reinforcing metal members 40 are fixed by soldering to the side of the top surface 30a, that is, one surface side of the substrate 30 by providing reflow treatment to the connection pads 50a and the mounting pads 50b. A mating convex portion of the complementary connector having a shape corresponding to the peripheral edge of the mating recess 21a is inserted from the side of the bottom surface 30b, that is, the other surface side of the substrate 30 into the mating recess 21a of the bottom entry connector 100 that has been mounted as described above, by which an electrical contact can be achieved.

In the bottom entry connector 100 constructed as described above, by providing the resilient arm 43, which engages with the peripheral edge of the opening 30c on the side of the bottom surface 30b, that is, the other surface side of the substrate 30, on the reinforcing metal member 40, the bottom entry connector 100 is fixed to the substrate 30. Therefore, during the period of movement from the positioning process to the soldering process, the movement of the bottom entry connector 100 relative to the substrate 30 is restrained.

By fixing the bottom entry connector 100 to the opening 30c in the substrate 30 by utilizing the resilient force of the resilient arm 43, an audible click is provided when the resilient arm 43 resiliently returns toward an unstressed position in which the arm is engaged with the side of the bottom surface 30b of the substrate. This provides a means by which a sense of mounting can be felt. Therefore, the worker can perform the work while confirming whether or not the bottom entry connector 100 has been properly positioned on the substrate.

Further, by fixing the bottom entry connector 100 to the substrate 30 by using the resilient arm 43, the bottom entry connector 100 can be inserted from the side of the top surface 30a of the substrate 30, or can be inserted from the side of the bottom surface 30b thereof.

Further, since the resilient arm 43 is protected by the paired flat plate shaped substrate fixing portions 42 because the resilient arm 43 is formed between the substrate fixing portions 42, a failure such as a bent resilient arm 43 caused by an external force applied when the bottom entry connector 100 is inserted through the substrate 30 or an entangled electric wire can be restrained effectively.

Further, since the substrate connecting portion 10a of the pin contact 10 is formed by being raised upward from the top surface 30a of the substrate 30 continuously with the contact portion 10c extending vertically, by being lowered diagonally by bending so as to be in contact with the connection pad 50a of the substrate 30, a stress applied to the soldered portion caused by a difference in the coefficient of linear expansion between the substrate 30 and the housing 20 can be absorbed. Therefore, warping occurring in the substrate 30 and the bottom entry connector 100 and solder cracking can be prevented, so that the electrical continuity between the substrate 30 and the bottom entry connector 100 can be kept good.

In this embodiment, the bottom entry connector 100 is a pin-side connector having the pin contacts 10. However, the present invention is not limited to this configuration, and can be applied to a socket-side connector having socket contacts.

Also, in this embodiment, the bottom entry connector 100 is inserted from the side of the top surface 30a of the substrate 30. However, the present invention is not limited to this configuration, and the bottom entry connector 100 may be inserted from the side of the bottom surface 30b of the substrate 30.

Further, the number and shape of the pin contacts 10 or the shape of the resilient arm 43 is not limited to the above-described one. Any configuration that can achieve the same effects as those of this embodiment may be used. For example, the resilient arm 43 may be formed by being lowered downward from the base portion 41 and by being bent into a U-like shape to be extended upward (in the reverse direction shown in the drawings).

As described above, in the bottom entry connector according to claim 1, by providing the resilient arm, which engages with the peripheral edge of the opening on the side opposite to the mounting surface side (one surface side), that is, the bottom surface side (the other surface side) of the substrate, on the reinforcing metal member, the bottom entry connector can be fixed to the substrate surely and easily. Therefore, during the period of movement from the positioning process to the soldering process, a positional shift between the substrate and the bottom entry connector can be prevented. Thereby, soldering can be performed and the work efficiency of soldering process can be

What is claimed is:

1. A connector for mounting to a substrate, the substrate having an opening for receipt of the connector therein, the opening extending from a first side surface of the substrate to a second side surface, the connector comprising:
a housing having contacts provided therein, the contacts have substrate connecting portions which are configured to make electrical connection with contact pads provided on the first surface of the substrate;
at least one reinforcing member mounted to the housing, the at least one reinforcing member having a substrate fixing portion and a resilient arm, the resilient arm cooperates with edges of the opening to prevent movement of the connector relative to the opening until the substrate fixing portion and the contacts are soldered to the substrate.

2. The connector as recited in claim 1 wherein the housing has two reinforcing members provided at opposed ends of the housing.

3. The connector as recited in claim 1 wherein the at least one reinforcing member has a base portion which is mounted in the housing, the substrate fixing portion extends from the base portion, the substrate fixing portion has two substrate fixing portion legs.

4. The connector as recited in claim 3 wherein the resilient arm extends from the base portion and is bent to form a unshaped member which is positioned between the substrate fixing portion legs.

5. The connector as recited in claim 3 wherein tapered surfaces are provided at an insertion end of the base portion, the tapered surfaces assist in the insertion of the base portion into the housing.

6. The connector as recited in claim 3 wherein barbs and protrusions are formed on the base portion to prevent the removal of the base portion from the housing.

7. The connector as recited in claim 4 wherein a tip end portion of the resilient arm has a curved face, whereby as the connector is fully inserted into the opening of the substrate, the resilient arm is slightly biased against a respective edge of the opening, causing the curved face of the resilient arm to engage the respective edge to maintain the connector is position relative to the substrate.

8. The connector as recited in claim 1 wherein the at least one reinforcing member is made from metal.

9. A reinforcing member for use in maintaining a connector is an opening of a substrate, the reinforcing member comprising:
the reinforcing member having a base portion, a substrate fixing portion and a resilient arm, the base portion cooperates with a housing to mount the reinforcing member to the housing, the resilient arm cooperates with an edge of the opening in the substrate to prevent movement of the connector relative to the opening until the substrate fixing portion is soldered to the substrate.

10. The reinforcing member as recited in claim 9 wherein the substrate fixing portion extends from the base portion, the substrate fixing portion has two substrate fixing portion legs which are spaced from each other and which are provided in essentially the same plane.

11. The reinforcing member as recited in claim 10 wherein the resilient arm extends from the base portion and is bent to form a unshaped member which is positioned between the substrate fixing portion legs.

12. The reinforcing member as recited in claim 9 wherein tapered surfaces are provided at an insertion end of the base portion, the tapered surfaces assist in the insertion of the base portion into the housing.

13. The reinforcing member as recited in claim 9 wherein barbs and protrusions are formed on the base portion to prevent the removal of the base portion from the housing.

14. The reinforcing member as recited in claim 9 wherein a tip end portion of the resilient arm has a curved face, whereby as the connector is fully inserted into the opening of the substrate, the resilient arm is slightly biased against a respective edge of the opening, causing the curved face of the resilient arm to engage the respective edge to maintain the connector is position relative to the substrate.

15. The reinforcing member as recited in claim 9 wherein the reinforcing member is made from metal.

16. The reinforcing member as recited in claim 9 wherein the reinforcing member is integrally molded to the housing.

17. A bottom entry connector comprising:
a contact, a housing for accommodating said contact, and a reinforcing metal member, the connector being mounted on a substrate by inserting a mating portion formed on the housing, which mates with a complementary connector, from a first surface side of an opening formed in the substrate, so that the mating portion extends beyond a second surface side of the substrate, a substrate connecting portion of said contact and a substrate fixing portion of said reinforcing metal member are soldered to the first surface side of said substrate,
the reinforcing metal member is provided with a resilient arm which engages with a peripheral edge of the opening on the second surface side of the substrate to maintain the connector in position relative to the opening prior to soldering the substrate connecting portion and the substrate fixing portion to the first surface side of said substrate.

18. The bottom entry connector according to claim 1 wherein a tip end portion of the resilient arm is curved to engage with the peripheral edge of the opening in the substrate.

19. The bottom entry connector according to claim 1 wherein the resilient arm is formed, by being bent in the vertical direction, between the substrate fixing portions formed in a horizontal direction into a flat plate shape, the substrate fixing portion having two spaced substrate fixing portion legs.

20. The bottom entry connector according to claim 1 wherein a base portion of the reinforcing metal member is inserted and secured into the housing in a direction perpendicular to a mating direction of the complementary connector.
